(19) United States
(12) Patent Application Publication
(10) Pub. No.: US 2005/0025895 A1
(43) Pub. Date: Feb. 3, 2005

(54) Coating device and coating method

(76) Inventor: Tohru Takeuchi, Yokohama-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/900,496

(22) Filed: Jul. 28, 2004

(30) Foreign Application Priority Data
Aug. 1, 2003 (JP) 2003-284905

(51) Int. Cl. B05D 1/02; B05C 5/00

(52) U.S. Cl. 427/421.1; 118/300

(57) ABSTRACT

The present invention provides a coating device comprising: a coating gun (4) which is provided with a coating discharge port (42) and an atomization gas discharge port (44) formed near the coating discharge port (42), and which can eject compressed gas from the atomization gas discharge port (44); and a coating cartridge (1) provided with a container (20) and a coating ejection nozzle (23) extending from the bottom of the container (20); wherein the coating cartridge (1) is removably mounted into the coating gun (4) so that the tip of the coating ejection nozzle (23) is approximately aligned with the coating discharge port (42). The coating device obviates washing process when the coating cartridges are exchanged.

### TECHNICAL FIELD

The present invention relates to a coating device and a coating method, and more specifically to a coating device and a coating method which can apply coatings while successively exchanging coating cartridges.

### BACKGROUND OF THE INVENTION

For many years, huge numbers of coating boards of multi-colored or multi-product-type coatings are prepared for color measurements and coating evaluations in processes such as compiling color-matching databases in order to use computer color matching (CCM) to determine coating formulations from colorimetric data, preparing progressive color panels for small-lot color adjustments, shipping inspections for companies in the coating industry, or the like. Applying various types or different colors of coating materials as described above raises problems concerning the coating material that remains when coating materials are exchanged. Therefore, a coating device has been proposed which reduces the amount of coating materials remaining by providing a coating gun with a removable coating cartridge (for example, Japanese Unexamined Patent Publication Nos. 11-347462 and 8-229446).

However, the coating device disclosed in Japanese Unexamined Patent Publication No. 11-347462 has a configuration such that the coating cartridge is attached to a connector on the coating gun body, and the coating material that is supplied to the coating gun body is ejected by compressed air. The coating gun body thus configured needs to be washed when coating cartridges are exchanged.

According to the coating device disclosed in Japanese Unexamined Patent Publication No. 8-229446, a coating nozzle provided on the coating cartridge leads the coating material to a bell head at the tip of the coating gun body, and the coating material is atomized by the rotation of the bell head and ejected by a shaping air flow. However, this coating device disadvantageously requires that the bell head and the tip of the coating nozzle be washed by spraying cleaning thinner from a washing nozzle provided on the coating gun body since the coating material adheres to the bell head.

As is clear from the above, the conventional cartridge-type coating device requires the coating gun body to be washed when coating materials are exchanged, and thus improvements have been desired to eliminate such complicated operation.

The devices disclosed in Japanese Unexamined Patent Publication Nos. 2000-176333 and 2003-93932 are currently known as devices that automatically exchange the coating cartridge inserted in the coating gun body. The automatic coating device disclosed in Japanese Unexamined Patent Publication No. 2000-176333 can automatically wash the coating material adhering to the bell head when the coating cartridges are exchanged, however such a device cannot solve problems such as generation of washing wastewater containing coating components and losses in working hours resulting from the washing operation.

### DISCLOSURE OF THE INVENTION

The present invention is made to solve the above-described problems and has an object to provide a coating device and a coating method which can eliminate a washing process when the coating cartridges are exchanged.

The object of the invention is accomplished by a coating device comprising: a coating gun which is provided with a coating discharge port and an atomization gas discharge port formed near the coating discharge port, and which can eject compressed gas from the atomization gas discharge port; and a coating cartridge provided with a container and a coating ejection nozzle extending from the bottom of the container, wherein the coating cartridge is removably mounted into the coating gun so that the tip of the coating ejection nozzle is approximately aligned with the coating discharge port.

The object of the invention is achieved by a coating method comprising: a mounting step in which a coating cartridge provided with a container and a coating ejection nozzle extending from the bottom of the container is removably mounted into a coating gun provided with a coating discharge port and an atomization gas discharge port formed near the coating discharge port so that the tip of the coating ejection nozzle is approximately aligned with the coating discharge port; and a coating step in which the coating material discharged from the coating discharge port is atomized by ejecting pressurized gas from the atomization gas discharge port, and the atomized coating material is applied as a coating.

### BRIEF DESCRIPTION OF DRAWINGS

FIG. 1 is a view illustrating an example of a coating method using a coating device according to one embodiment of the present invention.

FIG. 2 is a cross-section view schematically illustrating the coating device shown in FIG. 1.

FIG. 3 is a plane view schematically illustrating an example of an entire process including a coating process using the coating device shown in FIG. 1.

### BEST MODE FOR CARRYING OUT THE INVENTION

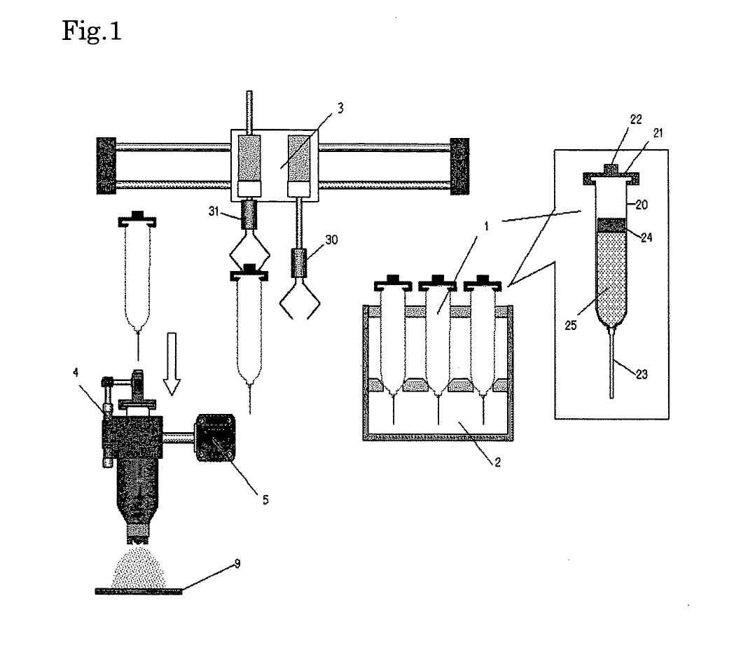

The present invention is now described below in detail according to several embodiments of the present invention with reference to drawings. FIG. 1 is a view illustrating an example of a coating process using a coating device according to one embodiment of the present invention.

As shown in FIG. 1, a plurality of coating cartridges 1 are individually contained in an cartridge stocker 2. Each coating cartridge 1 can eject coating material 25 by means of a pressure mechanism, and is provided with a cylindrical container 20 containing the coating material 25, a cap 21 provided at the top of the container 20 and having a pressurized gas supply port 22, a coating ejection nozzle 23 extending from the bottom of the container 20, and a movable plug 24 slidable along the inner surface of the container 20. The cap 21 is detachable with respect to the container 20, and compressed air fed from the pressurized gas supply port 22 pushes the movable plug 24 downward to extrude the coating material 25 contained in the container 20 from the coating ejection nozzle 23.

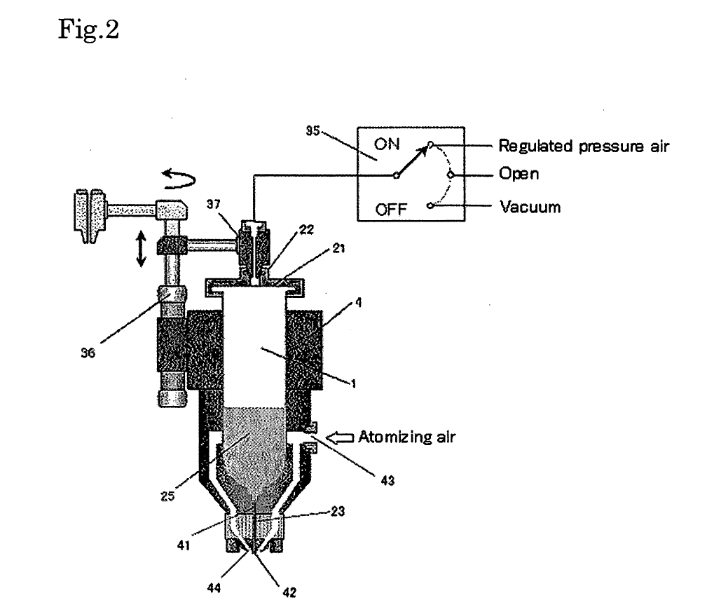

The movable plug 24 provided with the coating cartridge 1 is not necessarily required, and a configuration without a movable plug 24 is acceptable (see FIG. 2). In this case, a check valve (not shown) is preferably provided with the cap 21 so as to prevent the coating material contained in the container 20 from discharging.

Any material can be used without limitation for the container 20, cap 21, and coating ejection nozzle 23 insofar as they have sufficient dimensional stability and do not contaminate the coating material, and plastics, metals, etc. are applicable. It is possible to use a commercially available syringe container, etc. with the cap 21 installed thereon as the coating cartridge 1.

The coating cartridge 1 is automatically installed in a coating material gun 4 by a multiaxis robot 3. In FIG. 1, the multiaxis robot 3 is an XY carrier robot capable of moving grippers 30 and 31 upwards and downwards. The multiaxis robot 3 grips a desired coating cartridge from the cartridge stocker 2 and inserts it into the coating material gun 4. After application of the coating material is complete, the coating cartridge 1 is gripped again to be collected and exchanged. Thus, color changing coatings can be easily carried out by filling various colors of coating materials into a plurality of coating cartridges 1 individually contained in the cartridge stocker 2.

The multiaxis robot usable in this embodiment is not limited to an XY robot, and any carrier robot with a gripping function, such as an arm type material handling robot, etc. is usable.

The coating gun 4 of the present embodiment is a spray gun into which the coating cartridge 1 is removably inserted, and can travel over a coating target 9 by a coating gun-driving multiaxis robot 5 as shown in FIG. 1. The coating gun 4 is detachable with respect to the coating gun-driving multiaxis robot 5. Thus, coating guns 4 of various body sizes can be suitably selected to be attached to the coating gun-driving multiaxis robot 5.

FIG. 2 is a cross-section view schematically illustrating a coating device in which a coating gun 4 is equipped with a coating cartridge 1. As shown in FIG. 2, an insertion hole 41 is formed at the lower part of the coating gun 4. The coating cartridge 1 is held in the coating gun 4 by inserting the coating ejection nozzle 23 through the insertion hole 41 so that the tip of the coating ejection nozzle 23 is approximately aligned with the coating discharge port 42 located at the bottom end of the insertion hole 41.

The coating gun 4 is provided with a quick connector 37 to be inserted into a pressurized gas supply port 22 of the coating cartridge 1. The quick connector 37 is connected to a pressure suction unit 35 via air piping, and is supported so that it is vertically movable and rotatable by an air cylinder 36 with a rotating mechanism attached to the coating gun 4. By operating a switch, the pressure suction unit 35 can both supply compressed air to the coating cartridge 1 and extract air from the coating cartridge 1.

The coating gun 4 is provided with an atomization gas introduction port 43 capable of introducing a pressurized gas, such as compressed air, from a pressurized gas supply source (not shown). The compressed air supplied to the atomization gas introduction port 43 is ejected from atomization gas discharge ports 44 formed surrounding the vicinity of the coating discharge port 42.

The coating gun 4 thus configured accommodates the coating cartridge 1 therein by the operation of the multiaxis robot 3. The quick connector 37 is then rotated over the pressurized gas supply port 22 and lowered to the upper part thereof by the operation of the air cylinder 36 with a rotating mechanism. The lower part of the quick connector 37 is thus fitted to the pressurized gas supply port 22 to seal the coating cartridge 1.

Subsequently, the pressure suction unit 35 is operated to supply compressed air to the coating cartridge 1, and simultaneously compressed air is supplied to the atomization gas introduction port 43. The coating material 25 contained in the coating cartridge 1 is pressurized by the supplied compressed air and is then ejected from the coating discharge port 42 to be sprayed on the surface of the coating target in the form of a liquid mist produced by mixing it with compressed air ejected from the atomization gas discharge ports 44.

After the coating is complete, supply of the coating material 25 from the coating discharge port 42 is suspended by operating the switch of the pressure suction unit 35 to extract the air in the coating cartridge 1. Thus, it is possible to substantially avoid the coating material discharge immediately after supply stoppage by depressing the inside of the coating cartridge 1. Thereafter, the supply of compressed air to the atomization gas introduction port 43 is suspended.

Subsequently, the quick connector 37 is released from the upper part of the pressurized gas supply port 22 by elevating the quick connector 37 and then rotating by operating the air cylinder 36 with a rotating mechanism. Thus, the coating cartridges 1 are exchanged by operating the multiaxis robot 3 as described above.

The coating device of the present embodiment renders the coating material into a liquid mist by supplying compressed air from the vicinity of the tip of the coating ejection nozzle 23 from which the coating material 25 is supplied. After the coating is complete, any coating material adhering near the tip of the coating ejection nozzle 23 can be completely removed by blowing it away with the supplied compressed air. Accordingly, the coating gun 4 does not need to be washed when the coating cartridges 1 containing various colors or different types of coating materials are exchanged, thereby facilitating and speeding up exchange of the coating cartridges 1, and moreover reducing wasted coating materials and improving the coating environment.

When the coating device of the invention is used for preparing coating boards (progressive color panels) in color matching processes, the efficiency in terms of a coating material amount can be improved by adjusting the quantity of the coating material to be charged into the coating cartridge or selecting a coating gun with a body size suitable for the cartridge capacity.

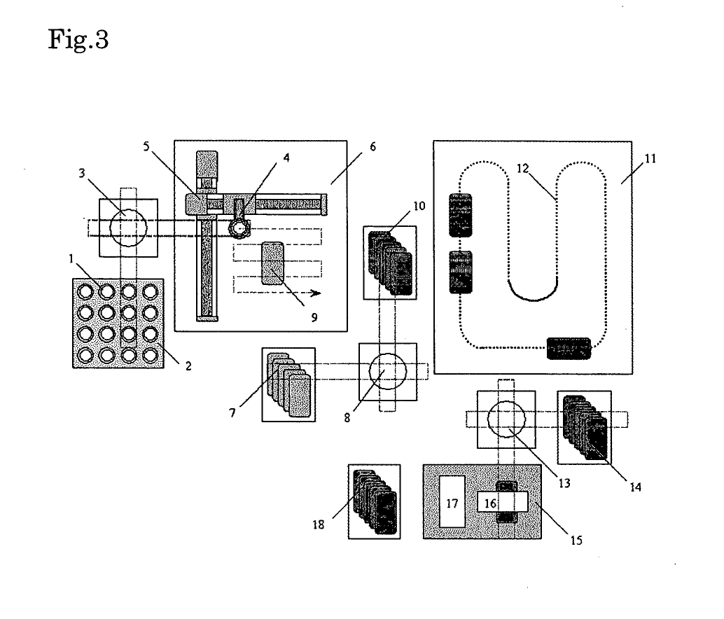

FIG. 3 is a plan view schematically illustrating an example of an entire process including a coating process using the coating device described above. A coating cartridge 1 accommodated in a cartridge stocker 2 is gripped by a multiaxis carrier robot 3, and is conveyed into a coating material booth 6 to be inserted into a coating gun 4 (see FIG. 2). In the coating material booth 6, the coating gun 4 accommodating the coating cartridge 1 is supported by a coating gun-driving multiaxis robot 5, and the coating material is applied onto a coating target 9, such as a tin plate, while passing over the target by moving the coating gun with the robot. After the coating is complete, the coating cartridge 1 is removed from the coating gun 4 by being gripped with the multiaxis carrier robot 3 to be returned to the cartridge stocker 2. Subsequently, another coating cartridge 1 is gripped, and then another coating can be carried out in the same manner as above.

A multiaxis carrier robot 8 grips coating targets 9 one by one from a coating target stocker 7 wherein a plurality of coating targets 9 are stored in a grippable state, and places them in a coating position in the coating material booth 6. After the coating is complete, coating boards made by coating the targets 9 are successively conveyed to a coating board buffer 10 for setting the boards. After the setting of the coating boards, the boards are successively mounted on a conveyor 12 of a dryer 11, and are dried for a predetermined period. The dried coating boards are successively conveyed to a coating board buffer 14 for cooling to room temperature for storage. A multiaxis carrier robot 13 grips the coating boards whose temperatures have been cooled to room temperature in the coating board buffer 14, conveys them to a coating board evaluation device 15, and places them in an appropriate position for evaluation. The coating board evaluation device 15 is provided with an appropriately selected colorimeter (spectrophotometer), DOI meter (image sharpness evaluator), etc., and evaluates the coating boards one by one. After evaluation, the coating boards are conveyed one by one to a coating board stocker 18 for storage.

During such a series of processes, a plurality of coating cartridges 1 are charged with various color coating materials, thereby facilitating color changing coatings and evaluation of the coating state. Since the entire process from the preparation of the coating boards to the evaluation of the coating state can be automated, the present invention is useful for achieving labor savings and full automation particularly in multi-colored coatings, such as compiling color matching database, small-lot color adjustments, etc., and the evaluation thereof.

### INDUSTRIAL APPLICABILITY

The coating device of the present invention is applicable not only to automatic coating using a multiaxis robot but also to manual coating in which the coating cartridges are exchanged by a coating worker. The present invention, when applied to manual coating, is extremely useful not only for applying the coating materials but for applying caulking compounds and putty materials.

The present invention is extremely useful for preparing an enormous number of coating boards using different colors or various types of coating materials or inks, and conducting the colorimetry and evaluation therefor, such as color matching in particularly automobile repair coating, etc., and also color-matching database creation and delivery inspection in the coating material and ink manufacturing industries, etc.

1. A coating device comprising:
a coating gun which is provided with a coating discharge port and an atomization gas discharge port formed near the coating discharge port, and which can eject compressed gas from the atomization gas discharge port; and
a coating cartridge provided with a container and a coating ejection nozzle extending from the bottom of the container; wherein
the coating cartridge is removably mounted into the coating gun so that the tip of the coating ejection nozzle is approximately aligned with the coating discharge port.

2. A coating device according to claim 1, wherein the coating cartridge is provided with an insertion hole through which the coating ejection nozzle is inserted.

3. A coating device according to claim 1, wherein the coating cartridge is provided with a pressurized gas introduction port capable of introducing pressurized gas into the container.

4. A coating device according to claim 3 further comprising a pressure suction unit connected to the pressurized gas introduction port, wherein
the pressure suction unit supplies pressurized gas to the coating cartridge, and extracts air from the coating cartridge.

5. A coating device according to claim 4 further comprising a connector which is connected to the pressure suction unit via piping, and is attached to the pressurized gas introduction port from above, wherein
the connector is supported so that it is vertically movable and rotatable.

6. A coating method comprising:
a mounting step in which a coating cartridge provided with a container and a coating ejection nozzle extending from the bottom of the container is removably mounted into a coating gun provided with a coating discharge port and an atomization gas discharge port formed near the coating discharge port so that the tip of the coating ejection nozzle is approximately aligned with the coating discharge port; and
a coating step in which the coating material discharged from the coating discharge port is atomized by ejecting pressurized gas from the atomization gas discharge port, and the atomized coating material is applied as a coating.

7. A coating method according to claim 6, wherein
the coating cartridge is provided with a pressurized gas introduction port capable of introducing pressurized gas into the container, and
the coating step includes a step in which the coating material is ejected from the coating discharge port by introducing pressurized air into the coating cartridge via the pressurized gas introduction port.

8. A coating method according to claim 7, wherein the coating step further includes a step of stopping the supply of the coating material from the coating discharge port by extracting air from the coating cartridge via the pressurized gas introduction port when the coating is complete.

9. A coating method according to claim 6 comprising, following the coating step, a step of removing the coating cartridge from the coating gun, and then inserting another coating cartridge containing a different type or different color of coating material.
